(19) United States
(12) Patent Application Publication
(10) Pub. No.: US 2025/0317610 A1
(43) Pub. Date: Oct. 9, 2025

(54) METHOD AND APPARATUS FOR CONTENT PLAYBACK

(71) Applicant: Comcast Cable Communications, LLC, Philadelphia, PA (US)

(72) Inventor: Alexander GILADI, Denver, CO (US)

(21) Appl. No.: 19/173,523

(22) Filed: Apr. 8, 2025

Related U.S. Application Data
(60) Provisional application No. 63/631,384, filed on Apr. 8, 2024.

(51) Int. Cl. H04N 21/234; H04N 21/254; H04N 21/81

(52) U.S. Cl. CPC H04N 21/23418; H04N 21/254; H04N 21/812

(57) ABSTRACT

Methods and systems are described for individualized ad insertion into content streaming by a client. A client device may request an ad MPD for one or more ad segments. The client device may receive an MPD patch in response. The MPD patch may include information indicative of storage locations for the URLs, and playback information associated with the one or more ad segments. The client device may send another ad MPD request to a content delivery network (CDN), which may return the ad MPD. The client device may apply the MPD patch to the received ad MPD, and may play back the one or more ad segments according to the information contained in the MPD patch. This may reduce processing and resource burdens associated with the network side's generating of individualized MPDs for the client.

### CROSS-REFERENCE TO RELATED APPLICATIONS

This application claims priority to U.S. Patent Application Ser. No. 63/631,384 filed Apr. 8, 2024, the contents of which is hereby incorporated by reference in its entirety for any and all purposes.

### BACKGROUND

Content streaming systems may provide for various ad insertion techniques, where ad segments are displayed via a playback device during content streaming. Typically, when a client device, such as a playback device, requests advertisement content, a proxy communicates with other entities of the corresponding content delivery network (CDN) to generate individualized media presentation descriptions (MPDs) for the playback device. However, this process of generating these individualized MPDs on the network side may place a large resource burden on the network. Accordingly, there is a need for improved techniques for client-side ad insertion.

### SUMMARY

This Summary is provided to introduce concepts that are further described herein. This Summary is not intended to be used to limit the scope of the claimed subject matter.

Methods and systems are described for individualized ad insertion into content streaming by a client. A client device, such as a playback device, may request an ad MPD for a content. A proxy, such as a HTTP server, may generate a MPD patch for the client device, which may include ad location information, beaconing instructions, playback restrictions for the content, and the like. The MPD patch may be sent to the client device. The client device may request the ad from the network, and apply the information of the MPD patch to the content. The client device may thus generate individualized ad playback decisions. This may reduce the congestion and processing burden experienced by network side entities.

### BRIEF DESCRIPTION OF THE DRAWINGS

The following detailed description is better understood when read in conjunction with the appended drawings. For the purposes of illustration, examples are shown in the drawings; however, the subject matter is not limited to specific elements and instrumentalities disclosed. In the drawings:

FIG. 1 shows an example system;

FIG. 2 shows an example method;

FIG. 3 shows an example method;

FIG. 4 shows an example method; and

FIG. 5 shows an example computing device.

### DETAILED DESCRIPTION OF ILLUSTRATIVE EMBODIMENTS

Methods and systems are described for individualized ad insertion into content streaming by a client. A client device, such as a playback device, may request for an ad MPD for playback of a content. A proxy, such as a HTTP server, may request ad segments for the client device based on parameters associated with the client device. The proxy may receive from the CDN location information for ad segments, beaconing information for the client device, and playback restrictions information for the ad segments or content. The proxy may generate a patch indicative of the location information, the beaconing information, and the playback restrictions, and may send the patch to the client device. The client device may, based on the patch, request the ad segment from the network, retrieve the ad segment, and may play back the ad segment according to the playback restriction information and the beaconing information of the patch. The client device may thus generate an individualized ad segment playback while minimizing the proxy's involvement in the ad request process. This may reduce the proxy's processing and resource burden associated with playback.

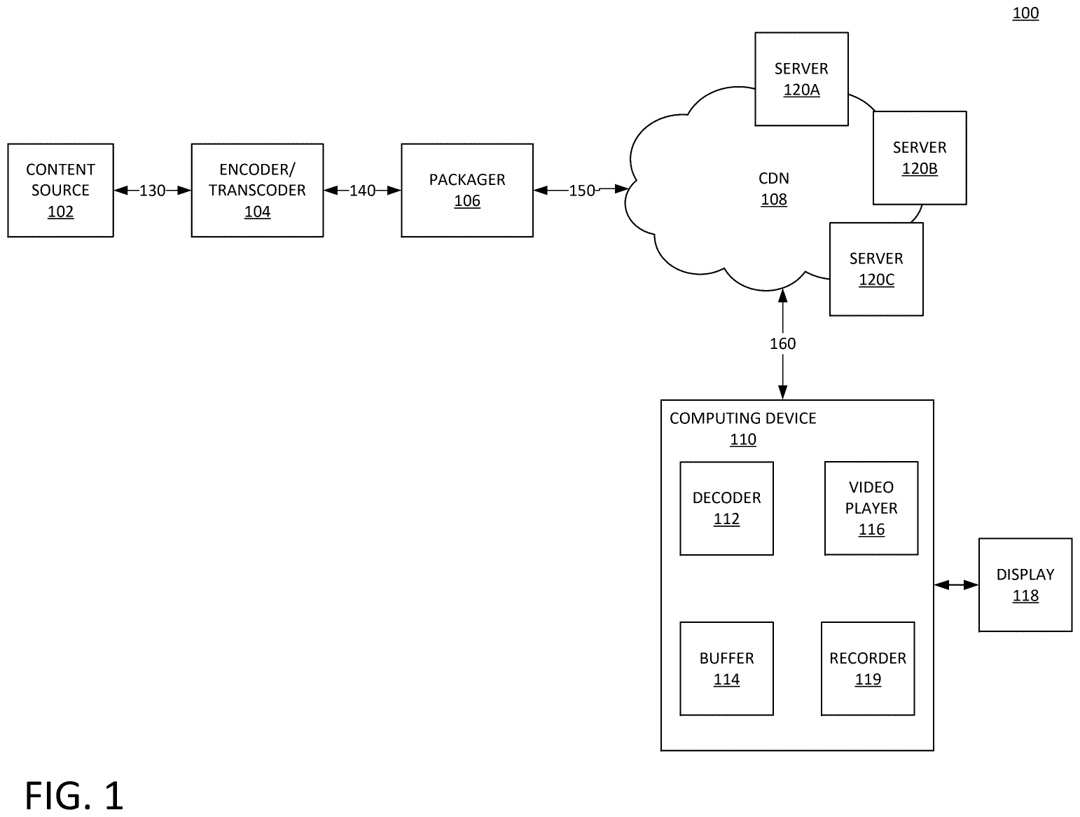

FIG. 1 shows system 100 for delivering content. The example system 100 may comprise a content source 102, an encoder/transcoder 104, a packager 106, a content delivery network (CDN) 108, and a computing device 110. The techniques for content delivery described herein are applicable to any content delivery method including but not limited to Dynamic Adaptive Streaming over HTTP (DASH), HTTP Live Streaming (HLS), the quadrature amplitude modulation (QAM) standard, and/or adaptive bit rate (ABR) streaming.

The computing device 110 may comprise a television, a monitor, a laptop, a desktop, a smart phone, a set-top box, a streaming-video player, a cable modem, a gateway, a tablet, a wearable computing device, a mobile computing device, any computing device configured to receive and/or render content, the like, and/or any combination of the foregoing. The computing device 110 may comprise a decoder 112, a buffer 114, a video player 116, and a digital video recorder (DVR) 119. The computing device 110 (e.g., the video player 116) may be communicatively connected to a display 118. The display 118 may be a separate and discrete component from the computing device 110, such as a television display connected to a set-top box. The display 118 may be integrated with the computing device 110. The decoder 112, the video player 116, the buffer 114, the DVR 119, and the display 118 may be realized in a single device, such as a laptop or mobile device. The decoder 112 may decompress/decode encoded video data. The encoded video data may be received from the encoder/transcoder 104, the packager 106, or the CDN 108.

The content source 102 may comprise a source feed of content from a provider. For example, the content source 102 may comprise a broadcast source, a service provider (e.g., a cable television service provider), an advertiser, a headend, a video on-demand server, a cable modem termination system, the like, and/or any combination of the foregoing. The content source 102 may send content 130 to the encoder/transcoder 104. The content 130 may comprise for example, a program, a television show, a movie, a sports event broadcast, an advertisement or the like. The content 130 may comprise video frames or other images. For example, the content 130 may comprise video frames in a Moving Picture Experts Group (MPEG) Single Program Transport Stream (MPEG-SPTS). The video frames may comprise pixels. A pixel may comprise the smallest controllable element of a video frame. The video frame may comprise bits for controlling each associated pixel. A portion of the bits for an associated pixel may control a luma value (e.g., light intensity) of each associated pixel. A portion of the bits for an associated pixel may control one or more chrominance value (e.g., color) of the pixel.

The content source 102 may receive requests for the content 130 from the encoder/transcoder 104, the packager 106, the computing device 110, or the CDN 108. The content source 102 may send content 130 to the encoder/transcoder 104 based on a request for content from the encoder/transcoder 104, the packager 106, the computing device 110, or the CDN 108. The content 130 may comprise uncompressed video data or a content stream such as an MPEG-SPTS.

The encoder/transcoder 104 may comprise an encoder, which may encode uncompressed video data received from the content source 102. The terms transcoder and encoder may be used interchangeably herein. The terms transcode and encode may be used interchangeably herein. The encoder/transcoder 104 may receive content from the content source 102. The content may be in any one of a variety of formats, such as, for example, H.264, MPEG-4 Part 2, or MPEG-2. The encoder/transcoder 104 may convert the content from one video format to another video format, such as one format compatible with the playback devices of the service provider's users (e.g., computing device 110). The encoder/transcoder 104 may additionally segment the content into a plurality of segments.

When uncompressed video data is received, the encoder may encode the video (e.g., into a compressed format) using a compression technique prior to transmission. The content source 102 and the encoder/transcoder 104 may be co-located at a premises, located at separate premises, or associated with separate instances in the cloud. The encoder 104 may comprise any type of encoder including but not limited to: H.264/MPEG-AVC, H.265/MPEG-HEVC, MPEG-5 EVC, H.266/MPEG-VVC, AVI, VP9, Global motion compensation (GMC), etc. The encoder/transcoder 104 may transcode the content 130 into one or more output streams 140. The one or more output streams 140 may comprise video encoded with different resolutions and/or different bit rates.

The packager 106 may receive the content from the encoder/transcoder 104. For example, the packager 106 may receive the one or more output streams 140 from the encoder/transcoder 104. The packager 106 may determine how the content is to be segmented and put together for delivery to and eventual playback by the computing device 110. As part of this process, the packager 106 may segment the content (such as in the event that the content has not yet been segmented) or may re-segment the content (such as in the event that the content had been previously segmented). The packager 106 may additionally insert one or more cues or markers into the content segments at which one or more additional segments, such as segments comprising an advertisement, may be inserted by an upstream client, server, or logical module.

The packager 106 may create a manifest file associated with the content. For example, the manifest may comprise a DASH manifest (e.g., a Media Presentation Description (MPD)). The manifest may comprise information describing various aspects of the associated content that may be useful for the computing device 110 to playback the content. For example, the manifest may indicate the availability of the segments comprising the content, the length of each segment, the number of segments, and/or the proper ordering of the segments necessary to cause playback of the content. The manifest may further include a network location (e.g., a hyper-text transfer protocol (HTTP) uniform resource locater (URL) link or other universal resource identifier (URI)) for each segment from which the segment may be downloaded, accessed, or retrieved.

The network locations included within the manifest may indicate more than one location or source. For example, the network location for segments corresponding to the content may reference a storage location while the network location for segments corresponding to an inserted advertisement may reference a location from outside the system 100 (e.g., at an advertising server). The manifest may describe multiple versions (e.g., different quality levels) of the content, including corresponding information on those segments. For example, manifest may describe multiple bit rate and/or resolution versions of the content. The manifest may be provided to the computing device 110 in response to a request to receive content. The computing device 110 may use the manifest file to determine the segments required to play the content or a segment/portion of the content and subsequently download the required segments using the network locations specified in the manifest file.

The packager 106 may generate one or more ABR streams 150 in different ABR streaming formats. The one or more ABR streams 150 may comprise segments or fragments of video and the manifest. The manifest may indicate availability of the ABR stream and segments/fragments and information for requesting the segments/fragments (e.g., via a URL). The packager 106 may send the one or more ABR streams 150 to the CDN 108.

The CDN 108 may comprise one or more computing devices such as servers 120A, 120B, 120C that store content (e.g., the one or more ABR streams 150). The CDN 108 may receive a request for content from the computing device 110. The request may be sent via HTTP. The CDN 108 may authorize/authenticate the request and/or the computing device 110 from which the request originated. The request for content may comprise a request for a channel, a recorded program, a video on-demand asset, a website address, a video asset associated with a streaming service, the like, and/or any combination of the foregoing. The CDN 108 may send the request to the content source 102, the encoder/transcoder 104, or the packager 106. The CDN 108 may send the requested content 160 to the computing device 110. The one or more servers 120A, 120B, 120C of the CDN 108 may serve the content 160 to the computing device 110.

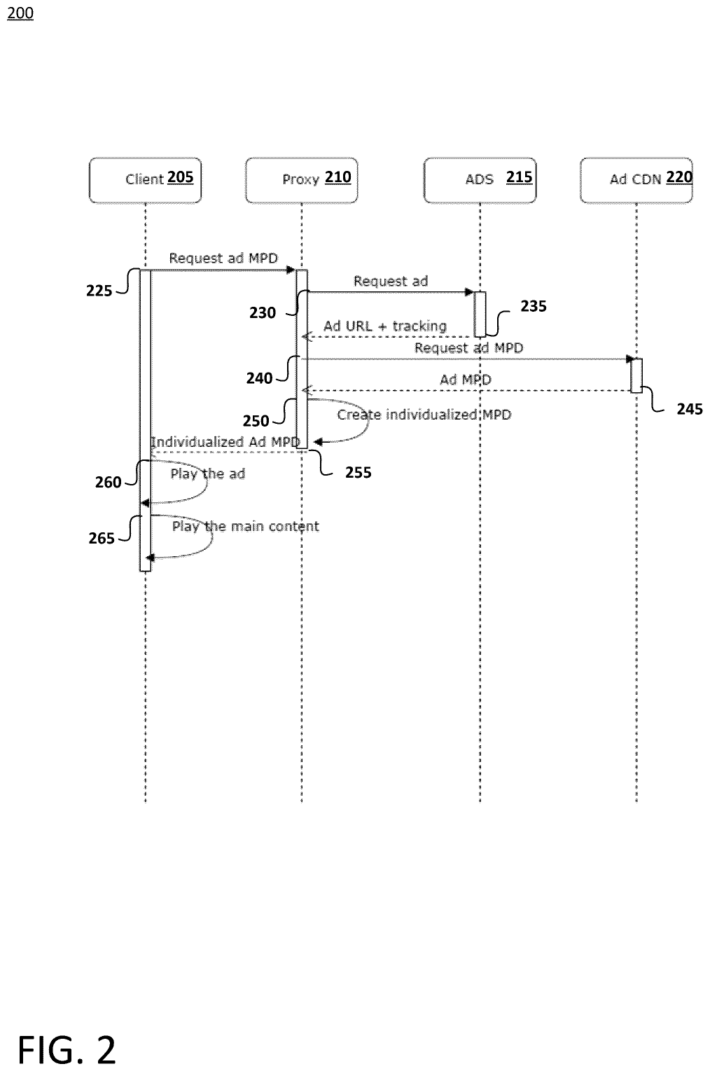

FIG. 2 shows an example method 200. The method 200 may be performed by a client 205, a proxy 210, an ad decisioning server (ADS) 215, and an Ad CDN 220. The client 205 may be a client device or playback device, and may thus be a client-side device. The proxy 210 may be a HTTP server or other types of web servers. The proxy 210, the ADS 215, and the ad CDN 220 may be part of a network, and may thus be referred to as network-side entities.

At Step 225, the client device 105 may send a request for an ad MPD to the proxy 210. The request may be a GET request. The request may include identification information of the client or client device. At Step 230, the proxy 210 may send an ad request to the ADS 215. The ad request may be a request for one or more ad segments specific for the identified client or client device.

At Step 235, the ADS 215 may send ad playback information to the proxy 210. The ad playback information may include location information for ad segments, such as URLs for the ad segments. The ad playback information may include beaconing instructions. The beaconing instructions may be instructions for the client device 205 to send beacons associated with the ad segments or the content. For example, the beaconing instruction may instruct the client device 205 to report ad playback progress (e.g., playback start, 25%, 50%, 100%, etc.,) of the ad played. The ad playback information may also include playback restrictions (e.g., trick modes) for the ad segment or the content. For example, the playback restrictions may include a disabling of fast forwarding or rewinding while the ad segment(s) are played back.

At Step 240, the proxy 210 may send a request for an ad MPD to the ad CDN 220. The request for the ad MPD may include a GET request for particular URL(s) corresponding to one or more ad segments. At Step 245, the ad CDN 220 may send an ad MPD to the proxy 210. The ad MPD may provide the one or more ad segments.

At Step 250, the proxy 210 may generate an individualized MPD for the client device 205. The individualized MPD may include the one or more ad segments, the beaconing information, and the playback restrictions for the ad segments. At Step 255, the proxy 210 may send the individualized MPD to the client device 205.

At Step 260, the client device 205 may play the one or more ad segments. The client device 205 may play back the one or more ad segments according to the beacon information and playback restrictions provided in the individualized ad MPD from the proxy 210. At Step 265, the client device 205 may play the main content, such as when the one or more ad segments are successfully played back. As shown in the method 200, the proxy 210 plays a large role in retrieval and playback of ad segments by the client device 205. This creates a large burden for the proxy 210, which may limit scaling of content streaming networks.

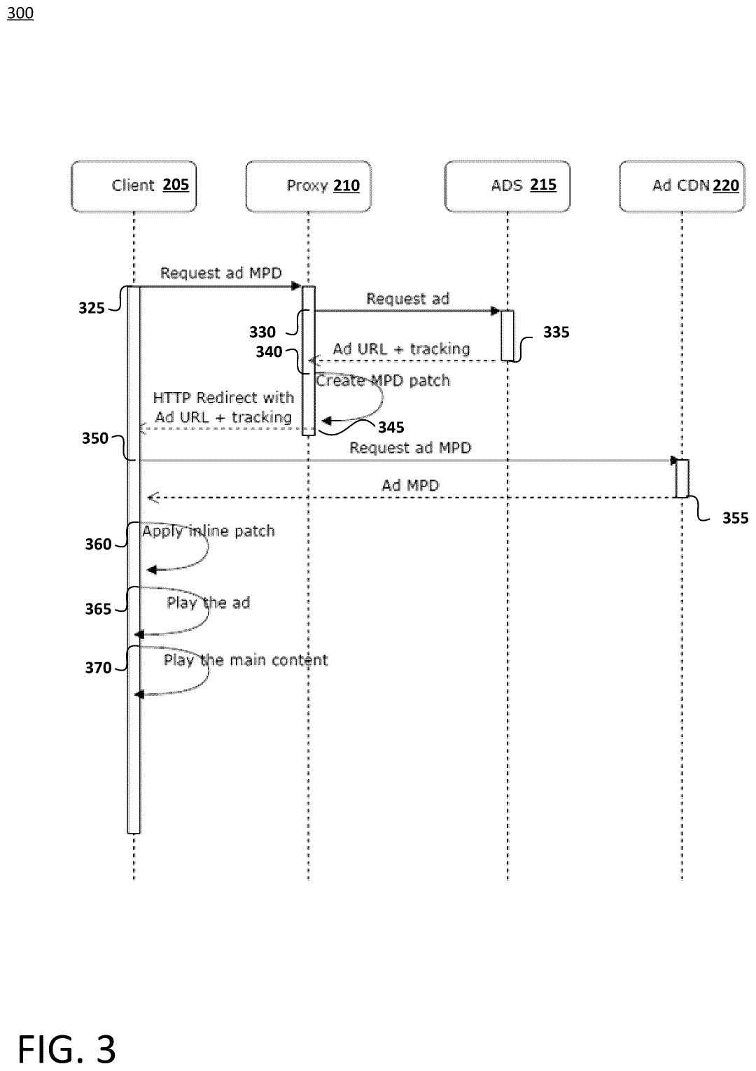

FIG. 3 shows an example method 300. The method 300 may be performed by a client 205, a proxy 210, an ADS 215, and an Ad CDN 220, each of may be examples of the respective entities as discussed with reference to the method 200 of FIG. 2.

At Step 325, the client device 205 may send a request for an ad MPD to the proxy 210. The request may be a GET request. The request may include identification information of the client or client device. At Step 330, the proxy 210 may send an ad request to the ADS 215. The ad request may be a request for one or more ad segments specific for the identified client or client device.

At Step 335, the ADS 215 may send ad playback information to the proxy 210. The ad playback information may include location information for ad segments, such as URLs for the ad segments. The ad playback information may include beaconing instructions. The beaconing instructions may be instructions for the client device 205 to send beacons associated with the ad segments or the content. For example, the beaconing instruction may instruct the client device 205 to report ad playback progress (e.g., playback start, 25%, 50%, 100%, etc.) of the ad played. The ad playback information may also include playback restrictions (e.g., trick modes) for the ad segment or the content. For example, the playback restrictions may include a disabling of fast forwarding or rewinding while the ad segment(s) are played back.

At Step 340, the proxy 210 may generate a MPD patch. The MPD patch may include location information for the one or more ad segments. The MPD patch may include beaconing information (e.g., tracking information in IAB VAST syntax) for the client device 205. The MPD patch include playback restriction information (e.g., playback speed restrictions as defined in SCTE 130-10) for the client device 205. The MPD patch may be XML elements, XPath expressions, etc.

At Step 345, the proxy 210 may send the MPD patch to the client device 205. In some cases, a URL of the MPD patch may be included in a named query parameter in an alternate MPD URL. The client device 205 may request the MPD patch via the patch's URL. In some cases, the MPD patch may be compressed (e.g., with a brotli compression algorithm, as based64-coded, etc.) and included in a URL query parameter in the MPD URL. The sending may also include a redirect response, such as a HTTP redirect response.

At Step 350, the client device 205 may send an ad MPD request to the ad CDN 220. The request may include identifying information for the client or the client device 205. At Step 355, the ad CDN 220 may send the ad MPD to the client device 205. At Step 360, the client device 205 may apply the MPD patch. The client device 205 may extract information from the MPD and insert the information into the ad MPD received from the ad CDN 220. For example, the client device 205 may insert the playback restriction information, beaconing information, and the like, as SupplementalProperty elements into the MPD.

At Step 365, the client device 205 may play the one or more ad segments. The one or more ad segments may be played according to the information contained in the MPD patch. For example, the client device 205 may send beacons according to an ad completion threshold (e.g., 25% of the ad played). As another example, the client device 205 may disable or enable trick modes indicated in the MPD patch. At Step 370, the client device 205 may play the main content.

As another example, XLink may be used instead of redirect transmissions and MPD query parameters. For example, EventStream element may be a remote element. If tracking is implemented using EventStream (e.g., with DASH callback events or VAST embedded in events), then the XLink resolution may take place at the time the Alternative MPD is parsed and the client may have the necessary information. The ad MPDs from the ad CDN 220 may include an XLink URL in them. However, the actual resolution may occur in real time. The XLink request may mirror the query parameters used with the ad MPD as discussed above, which in turn may be inherited from the main MPD URL. This way, the XLink request may be personalized.

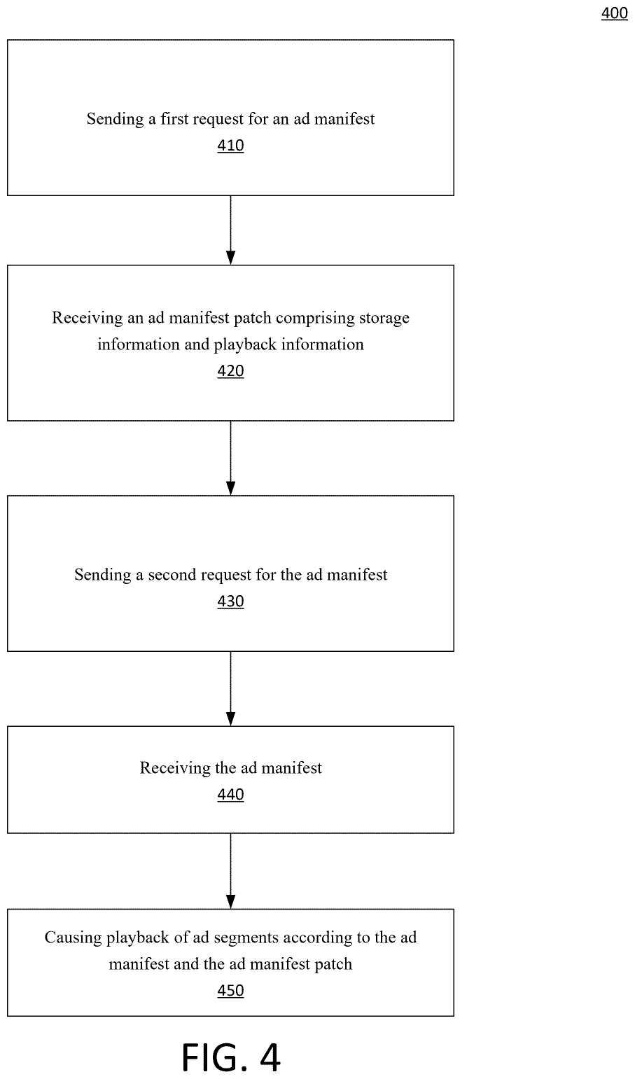

FIG. 4 shows an example method 400. The method 400 of FIG. 4 may be performed by any device, for example, by any of the devices depicted in FIG. 1 or described herein. While each step in the method 400 of FIG. 4 is shown and described separately, multiple steps may be executed in a different order than what is shown, in parallel with each other, or concurrently with each other.

At Step 410, the client device may send a first request for an ad media presentation description (MPD) for one or more ad segments The MPD may also be referred to as an ad manifest or ad manifest file. The first request may be sent to a first server. In some cases, the first server may be a HTTP or web server.

At Step 420, the client device may receive from the first server an ad manifest patch (e.g., a MPD patch) in response to the first request. The ad manifest patch may include information indicative of a storage location for the one or more ad segments and playback information associated with the one or more ad segments. In some cases, the playback information may include beaconing instructions associated with the one or more ad segments, playback restrictions for the one or more ad segments (e.g., fast forward restrictions for the one or more ad segments), or both.

At Step 430, the client device may send, to a second server, a second request for the ad manifest for the one or more ad segments. In some cases, the second server may be an ad content delivery network (CDN) server. In some cases, the second request may be a redirect of the first request. In some cases, the ad manifest patch may be received in a redirect response from the first server, such as a HTTP 302 redirect response, which may cause the client device to send the second request.

At Step 440, the client device may receive from the second server the ad manifest for the one or more ad segments. In some cases, the client device may apply the ad manifest patch to the ad manifest for the one or more ad segments. In some cases, applying the ad manifest patch may include extracting information indicative of the playback information, and inserting the information into the ad manifest, such as in one or more supplemental property fields. In some cases, the client device may cause playback of the one or more ad segments according to the ad manifest patch.

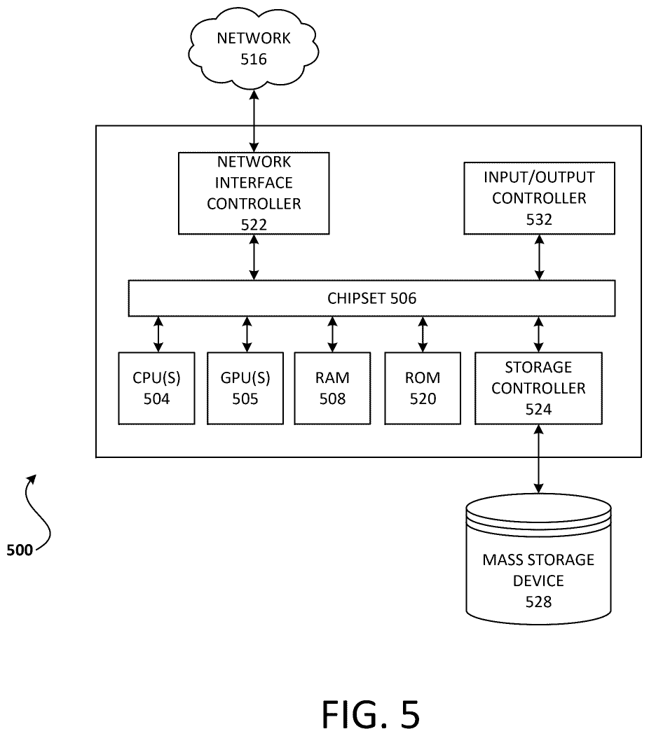

FIG. 5 depicts a computing device that may be used in various aspects, such as the servers, modules, and/or devices depicted in FIGS. 1-4. With regard to the example architecture of FIGS. 1-4, each device depicted in FIGS. 1-4 may be implemented in an instance of a computing device 500 of FIG. 5. The computer architecture shown in FIG. 5 shows a server computer, workstation, desktop computer, laptop, tablet, network appliance, PDA, e-reader, digital cellular phone, or other computing node, and may be utilized to execute any aspects of the computers described herein, such as to implement the methods described in relation to FIGS. 1-4.

The computing device 500 may comprise a baseboard, or “motherboard,” which is a printed circuit board to which a multitude of components or devices may be connected by way of a system bus or other electrical communication paths. One or more central processing units (CPUs) 504 may operate in conjunction with a chipset 506. The CPU(s) 504 may be standard programmable processors that perform arithmetic and logical operations necessary for the operation of the computing device 500.

The CPU(s) 504 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 504 may be augmented with or replaced by other processing units, such as GPU(s) 505. The GPU(s) 505 may comprise processing units specialized for but not necessarily limited to highly parallel computations, such as graphics and other visualization-related processing.

A chipset 506 may provide an interface between the CPU(s) 504 and the remainder of the components and devices on the baseboard. The chipset 506 may provide an interface to a random access memory (RAM) 508 used as the main memory in the computing device 500. The chipset 506 may provide an interface to a computer-readable storage medium, such as a read-only memory (ROM) 520 or non-volatile RAM (NVRAM) (not shown), for storing basic routines that may help to start up the computing device 500 and to transfer information between the various components and devices. ROM 520 or NVRAM may also store other software components necessary for the operation of the computing device 500 in accordance with the aspects described herein.

The computing device 500 may operate in a networked environment using logical connections to remote computing nodes and computer systems through local area network (LAN) 516. The chipset 506 may include functionality for providing network connectivity through a network interface controller (NIC) 522, such as a gigabit Ethernet adapter. A NIC 522 may be capable of connecting the computing device 500 to other computing nodes over a network 516. It should be appreciated that multiple NICs 522 may be present in the computing device 500, connecting the computing device to other types of networks and remote computer systems.

The computing device 500 may be connected to a mass storage device 528 that provides non-volatile storage for the computer. The mass storage device 528 may store system programs, application programs, other program modules, and data, which have been described in greater detail herein. The mass storage device 528 may be connected to the computing device 500 through a storage controller 524 connected to the chipset 506. The mass storage device 528 may consist of one or more physical storage units. A storage controller 524 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 500 may store data on a mass storage device 528 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 528 is characterized as primary or secondary storage and the like.

For example, the computing device 500 may store information to the mass storage device 528 by issuing instructions through a storage controller 524 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 500 may read information from the mass storage device 528 by detecting the physical states or characteristics of one or more particular locations within the physical storage units.

In addition to the mass storage device 528 described herein, the computing device 500 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 500.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 528 depicted in FIG. 5, may store an operating system utilized to control the operation of the computing device 500. The operating system may comprise a version of the LINUX operating system. The operating system may comprise a version of the WINDOWS SERVER operating system from the MICROSOFT Corporation. According to additional aspects, the operating system may comprise a version of the UNIX operating system. Various mobile phone operating systems, such as IOS and ANDROID, may also be utilized. It should be appreciated that other operating systems may also be utilized. The mass storage device 528 may store other system or application programs and data utilized by the computing device 500.

The mass storage device 528 or other computer-readable storage media may also be encoded with computer-executable instructions, which, when loaded into the computing device 500, transforms the computing device from a general-purpose computing system into a special-purpose computer capable of implementing the aspects described herein. These computer-executable instructions transform the computing device 500 by specifying how the CPU(s) 504 transition between states, as described herein. The computing device 500 may have access to computer-readable storage media storing computer-executable instructions, which, when executed by the computing device 500, may perform the methods described in relation to FIGS. 1-4.

A computing device, such as the computing device 500 depicted in FIG. 5, may also include an input/output controller 532 for receiving and processing input from a number of input devices, such as a keyboard, a mouse, a touchpad, a touch screen, an electronic stylus, or other type of input device. Similarly, an input/output controller 532 may provide output to a display, such as a computer monitor, a flat-panel display, a digital projector, a printer, a plotter, or other type of output device. It will be appreciated that the computing device 500 may not include all of the components shown in FIG. 5, may include other components that are not explicitly shown in FIG. 5, or may utilize an architecture completely different than that shown in FIG. 5.

As described herein, a computing device may be a physical computing device, such as the computing device 500 of FIG. 5. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes¬ from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

The present methods and systems may be understood more readily by reference to the following detailed description of preferred embodiments and the examples included therein and to the Figures and their descriptions.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described herein may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed:

1. A method comprising:
sending, by a client device and to a first server, a first request for an ad manifest corresponding to a content;
receiving, by the client device and from the first server, an ad manifest patch in response to the ad manifest, wherein the ad manifest patch comprises information indicative of a storage location for one or more ad segments and playback information associated with the one or more ad segments;
sending, by the client device and to a second server, a second request for the ad manifest according to the ad manifest patch;
receiving, by the client device and from the second server, the ad manifest corresponding to the content; and
causing playback of one or more ad segments according to the ad manifest and the ad manifest patch.

2. The method of claim 1, further comprising:
applying the ad manifest patch to the ad manifest.

3. The method of claim 2, wherein the applying the ad manifest patch further comprises:
determining, from the ad manifest patch, information indicative of the playback information; and
inserting the information indicative of the playback information into the ad manifest.

4. The method of claim 3, wherein the information indicative of the playback information is inserted into one or more supplemental property fields of the ad manifest.

5. The method of claim 1, wherein the playback information comprises beaconing instructions associated with the one or more ad segments, playback restrictions for the one or more ad segments, or both.

6. The method of claim 5, wherein the playback restrictions comprise a restriction of fast forwarding during playback of the one or more ad segments.

7. The method of claim 1, wherein the first server comprises an HTTP server, the second server comprises an ad content delivery network (CDN) server, or both.

8. The method of claim 1, wherein sending the second request comprises redirecting the first request, according to the ad manifest patch and to the second server.

9. The method of claim 1, wherein the ad manifest patch is received in a redirect response from the first server.

10. The method of claim 9, wherein the redirect response comprises a HTTP 302 redirect response.

11. A computing device, comprising:
one or more processors;
memory; and
a set of instructions stored in the memory that, when executed by the one or more processors, cause:
sending, by a computing device and to a first server, a first request for an ad manifest corresponding to a content;
receiving, by the computing device and from the first server, an ad manifest patch in response to the ad manifest, wherein the ad manifest patch comprises information indicative of a storage location for one or more ad segments and playback information associated with the one or more ad segments;
sending, by the computing device and to a second server, a second request for the ad manifest according to the ad manifest patch;
receiving, by the computing device and from the second server, the ad manifest corresponding to the content; and
causing playback of one or more ad segments according to the ad manifest and the ad manifest patch.

12. The computing device of claim 11, wherein the set of instructions, when executed by the one or more processors, further cause:
applying the ad manifest patch to the ad manifest.

13. The computing device of claim 12, wherein the applying the ad manifest patch further comprises:
determining, from the ad manifest patch, information indicative of the playback information; and
inserting the information indicative of the playback information into the ad manifest.

14. The computing device of claim 13, wherein the information indicative of the playback information is inserted into one or more supplemental property fields of the ad manifest.

15. The computing device of claim 11, wherein the playback information comprises beaconing instructions associated with the one or more ad segments, playback restrictions for the one or more ad segments, or both.

16. A non-transitory, computer-readable medium comprising a set of computer-executable instructions that, when executed by one or more processors, cause:
sending, by a client device and to a first server, a first request for an ad manifest corresponding to a content;
receiving, by the client device and from the first server, an ad manifest patch in response to the ad manifest, wherein the ad manifest patch comprises information indicative of a storage location for one or more ad segments and playback information associated with the one or more ad segments;
sending, by the client device and to a second server, a second request for the ad manifest according to the ad manifest patch;
receiving, by the client device and from the second server, the ad manifest corresponding to the content; and
causing playback of one or more ad segments according to the ad manifest and the ad manifest patch.

17. The non-transitory, computer-readable medium of claim 16, wherein the set of instructions, when executed by the one or more processors, further cause:
applying the ad manifest patch to the ad manifest.

18. The non-transitory, computer-readable medium of claim 17, wherein the applying the ad manifest patch further comprises:
determining, from the ad manifest patch, information indicative of the playback information; and
inserting the information indicative of the playback information into the ad manifest.

19. The non-transitory, computer-readable medium of claim 18, wherein the information indicative of the playback information is inserted into one or more supplemental property fields of the ad manifest.

20. The non-transitory, computer-readable medium of claim 16, wherein the playback information comprises beaconing instructions associated with the one or more ad segments, playback restrictions for the one or more ad segments, or both.
